(19) United States
(12) Patent Application Publication
(10) Pub. No.: US 2025/0114934 A1
(43) Pub. Date: Apr. 10, 2025

(54) METHOD FOR OPERATING A MODULAR ROBOT, CONTROLLER AND MODULAR ROBOT

(71) Applicant: Beckhoff Automation GmbH, Verl (DE)

(72) Inventors: Guido Beckmann, Verl (DE); Thomas Rettig, Rheda-Wiedenbrück (DE); Uwe Bonin, Augsburg (DE); Peter Fischer, Hartberg (AT); Peter Kastler, Wien (AT); Armin Pehlivan, Nüziders (AT); Thomas Morscher, Wien (AT); Milos Winter, Wien (AT); Christoph Egger, Wien (AT); Christoph Zech, Mödling (AT)

(21) Appl. No.: 18/984,313

(22) Filed: Dec. 17, 2024

Related U.S. Application Data
(63) Continuation of application No. PCT/EP2023/065105, filed on Jun. 6, 2023.

(30) Foreign Application Priority Data
Jun. 21, 2022 (DE) 10 2022 115 411.4

(51) Int. Cl. B25J 9/08; B25J 9/16; B25J 18/04

(52) U.S. Cl. CPC B25J 9/08; B25J 9/1661; B25J 18/04

(57) ABSTRACT

A method is related for operating a modular robot. The modular robot comprises a robot base, at least a robot arm arranged on the robot base and a controller. The robot arm comprises a plurality of modularly arrangeable arm modules. The controller carries out steps described herein. Allocation information is received from each of the arm modules in an allocation determining step. In an arm module base data determining step, arm module base data is determined for each arm module based on the allocation information. Further, a configuration of the modular robot is created from the association information and the arm module base data of each arm module in a configurating step, where the configuration is used to control the robot arm.

### CROSS-REFERENCE TO RELATED APPLICATIONS

This patent application is a continuation of International Patent Application PCT/EP2023/065105, filed Jun. 6, 2023, entitled “Method for Operating a Modular Robot, Control Unit, Modular Robot and Arm Module,” which claims the priority of German patent application DE 10 2022 115 411.4, filed Jun. 21, 2022, entitled “Verfahren zum Betreiben eines modularen Roboters, Kontrolleinheit, modularer Roboter, Armmodul,” each of which is incorporated by reference herein, in the entirety and for all purposes.

### FIELD

The invention relates to a method for operating a modular robot, a controller for a modular robot and a modular robot.

### BACKGROUND

The purpose of automation technology (implementation, measurement, control/regulation, communication, human-machine interaction, safety, etc.) is to automate machines, including industrial robots and/or systems, i.e. to be able to operate them independently and without human intervention. The higher the degree of automation (ratio of automated production steps to all production steps) in an automation system, the more independent a particular machine in a system and/or a system in question is from human intervention.

The objects of automation technology include relieving people of dangerous, strenuous and/or monotonous activities, improving the quality of the products manufactured by the technical system, increasing the performance of the system and reducing costs through the system. Due to advances in machines, signal acquisition, signal processing and/or communication (networking) of components within the automation system, the degree of automation of an existing or new system may be significantly increased compared to the state of the art.

Application-specific industrial robots (manipulators) are an integral part of automated systems. An industrial robot is a programmable machine for handling, assembling and/or processing workpieces. The industrial robot generally comprises a robot arm (manipulator) having a number of arm links that may swivel and/or rotate in relation to one another, an (end)-effector (robot hand, tool, gripper, etc.), a local controller/regulator and, if necessary, a global controller/regulator. Industrial robots are frequently equipped with different sensors. When programmed, the industrial robot is able to carry out a work process autonomously or to change the execution of a task depending on information from a sensor, for example.

DE 10 2020 115 448 A1 discloses a modular industrial robot, hereinafter also referred to as a modular robot, consisting of a plurality of arm modules, wherein the arm modules form a modular robot arm. In contrast to conventional industrial robots, which are created and configured once, a modular industrial robot may be modified in its module arrangement or supplemented by further modules or existing modules may be shortened if additional or different movements are required. This allows for a cost-saving configuration of the industrial robot for the respective application and/or simple reuse of the industrial robot modules. However, the modular industrial robot must be reconfigured after each conversion.

There is a need to provide a method for operating a modular robot, with the aid of which the configuration of the modular robot is simplified. Furthermore, it is an object of the invention to provide a controller for a modular robot with the aid of which the method may be carried out. A further object of the invention is to provide a modular robot and an arm module for a modular robot, which also allow for a simplified configuration.

### SUMMARY

According to a first aspect, a method operates a modular robot, the modular robot comprising a robot base, at least a robot arm arranged on the robot base and a controller, the robot arm comprising a plurality of arm modules which may be arranged in a modular manner, the controller carrying out the following steps:

receiving allocation information from each of the arm modules in an allocation determining step;

determining arm module base data based on the allocation information for each arm module in an arm module base data determining step;

creating a configuration of the modular robot from the allocation information and the arm module base data of the individual arm modules in a configurating step, wherein the configuration is used to control the robot arm.

According to a second aspect, a method for operating a modular robot, the modular robot comprising a robot base, at least a robot arm arranged on the robot base and a controller, wherein the controller, the robot base and the arm modules forming the robot arm are connected to one another via a field bus and data are exchanged between the arm modules, the robot base and the controller via the field bus, wherein a data telegram is sent out by the controller and the field bus sends the data telegram through all arm modules via a ring line and subsequently the data telegram returns to the controller, wherein each arm module is a bus subscriber and comprises a switch-on unit for the field bus, the controller carrying out the following steps:

receiving allocation information from each of the arm modules in an allocation determining step, wherein each switch-on unit writes the allocation information into the data telegram, wherein the allocation information of each arm module includes a unique allocation number;

determining arm module base data based on the allocation information for each arm module in an arm module base data determining step, wherein the arm module base data include at least kinematic data;

creating a configuration of the modular robot from the allocation information and the arm module base data of the individual arm modules in a configurating step, wherein on the basis of the order of the allocation information of the arm modules, a mechanical structure of the robot arm is determined in the data telegram of the field bus;

controlling the robot arm on the basis of the determined configuration.

According to a third aspect, a controller for operating a modular robot, the modular robot comprising a robot base, at least a robot arm arranged on the robot base, wherein the controller, the robot base and the arm modules forming the robot arm are connected to one another via a field bus and data are exchanged between the arm modules, the robot base and the controller via the field bus. A data telegram is sent out by the controller and the field bus sends the data telegram through all arm modules via a ring line and subsequently the data telegram returns to the controller, wherein each arm module is a bus subscriber and comprises a switch-on unit for the field bus.

The controller receives allocation information from each of the arm modules in an allocation determining step, wherein each switch-on unit writes the allocation information into the data telegram, wherein the allocation information of each arm module includes a unique allocation number, wherein the controller determines arm module base data based on the allocation information for each arm module in an arm module base data determining step, wherein the arm module base data include at least kinematic data, wherein the controller creates a configuration of the modular robot from the allocation information and the arm module base data of the individual arm modules in a configurating step, wherein on the basis of the order of the allocation information of the arm modules, a mechanical structure of the robot arm is determined in the data telegram of the field bus, and wherein the controller controls the robot arm on the basis of the determined configuration.

### EXAMPLES

A method operates a modular robot, wherein the modular robot comprises a robot base, at least one robot arm arranged on the robot base and a controller. The robot arm comprises a plurality of arm modules that may be arranged in a modular fashion. Furthermore, the robot arm may comprise an end flange, wherein the end flange is arranged at one end of the robot arm. For example, a tool may be attached to the end flange. The controller carries out the steps described below. First, allocation information is received from each of the arm modules in an allocation determining step. Then, arm module base data is determined based on the allocation information for each arm module in an arm module base data determining step. Then, a configuration of the modular robot is created from the allocation information and the arm module base data of each arm module, and the configuration is used to drive the robot arm.

The allocation information may, for example, receive a unique allocation number, a serial number, a manufacturer identification number, a product number and/or a version number, which individually or in combination form the allocation information or from which the allocation information is calculated, for example as a checksum. The controller may, for example, query the allocation information for each arm module and receive a manufacturer identification number, a product number and a version number in response, which together form the allocation information or from which the allocation information is calculated, for example as a checksum.

In particular, the configuration of the modular robot may include which arm modules are arranged in the robot arm, the order in which these arm modules are arranged in relation to one another, how these arm modules may be moved in relation to one another, how these arm modules may be moved and whether there are branches in the robot arm. Furthermore, the configuration may include the speed and acceleration by which individual arm modules may be moved. The configuration may also include whether individual arm modules are active or passive. Passive arm modules do not contain a motor and serve as an extension of active arm modules. Active arm modules comprise at least one motor. In addition, it may be provided that the configuration includes characteristics of the arm modules, such as a characteristic curve of a drive motor of an arm module. Then, for example, a movement of the arm module may be controlled using the characteristic curve. The controller may be a controller and/or a regulator for the modular robot.

A controller for a modular robot is set up to carry out the method according to the invention. For this purpose, the controller may comprise a computing unit on which a program runs and which causes the controller to carry out the method steps. The controller may be a controller that controls the movements of the modular robot. Furthermore, the controller may also be a controller with the aid of which the modular robot is controlled on the basis of values measured in the arm modules, thus providing a control system. The controller may therefore be used to determine a configuration of the modular robot and, as the case may be, to determine changes to the configuration. The modular robot may then be controlled based on the configuration.

An arm module for a modular robot comprises an arm module memory. An allocation information is stored in the arm module memory. The arm module is set up to output the allocation information to a controller of the modular robot. Such an arm module may be used in the modular robot and allows for the controller to receive the allocation information. The arm module memory may either be arranged in the arm module or be embodied as an external memory connected to the arm module wirelessly or as a wired connection, for example in a network and/or a cloud.

An allocation information of the robot base is additionally received in the allocation determining step and/or arm module base data of the robot base is determined in the arm module base data determining step, the allocation information of the robot base and/or the arm module base data of the robot base being taken into account when the configuration of the modular robot is created in the configurating step. Thus, even if different robot bases may be used, the allocation information and/or arm module base data of the respective robot base used may always be taken into account when creating the configuration.

The arm module base data includes at least kinematic data. The kinematic data includes a relative position of a first flange and a second flange of the respective arm modules and/or the robot base. The arm modules could be connected to one another and/or to a tool via the first flanges or the second flanges. Furthermore, the kinematic data may be determined theoretically by simulation or practically by measurement during the production of the arm module. The kinematic data may be stored in the form of a 4×4 transformation matrix or as Denavit-Hartenberg parameters.

The kinematic data may then be used to generate a kinematic description of the entire modular robot. This kinematic description may be used to plan movements of the robot arm. This may be embodied in particular as Cartesian monitoring, in which a speed of a point, for example a tool center point, an L-bend of a robot arm or one of the flanges is monitored. A volume of a tool may be taken into account and a plurality of points of the tool, for example a gripper, may also be monitored. Furthermore, space monitoring, monitoring the geometry of the modular robot in relation to a space and/or a geometric object, monitoring whether the modular robot is occupying a certain space and/or checking whether the modular robot is within a permitted range of movement are possible.

This may be used, for example, in a material loading station of an automation system. If a human operator and/or a part of the human operator's body is in the area of the material loading station, for example behind an open roller shutter, the material loading station may be blocked for the modular robot. As soon as the human operator is no longer in the area of the material loading station, the space is unblocked and the modular robot may then move there again. Spaces may also be used as switches, i.e. as soon as the robot moves into a space, criteria may apply to the robot. For example, the modular robot may occupy this space, but the modular robot must move more slowly here. Different logic functions and this information may be used accordingly to generate a monitoring function. It may be intended to monitor states of the modular robot, such as a speed, a location and/or an orientation of the tool, and to logically interconnect states. A calculation of a forward transformation may be important for this.

The kinematic data may include a three-dimensional model of the modular robot, with the aid of which, for example, a shell or external dimensions of the modular robot may be taken into account. The kinematic data may also include kinematic correction data. The kinematic correction data may describe deviations from design data that arise, for example, due to inaccuracies during production. The kinematic correction data is recorded after production and stored in the memory, allowing the production tolerances of the modules to be taken into account.

The controller, the robot base and the arm modules forming the robot arm are connected to one another via a field bus. Data is exchanged between the arm modules, the robot base and the controller via the field bus. In the allocation determining step, the controller uses a sequence of the allocation information of the arm modules in a telegram of the field bus to determine a mechanical structure of the robot arm. In particular, a data telegram may be sent out by the controller and the field bus may send the data telegram via a ring line through all arm modules and then the data telegram returns to the controller. Each arm module is a bus subscriber and may, for example, have a switch-on unit for the fieldbus. Each switch-on unit may then write the allocation information to the data telegram, for example on request by the controller.

The controller may, for example, query the allocation information for each arm module and receive a manufacturer identification number, a product number and a version number in response, which together form the allocation information or from which the allocation information is calculated, for example as a checksum. Furthermore, a device description of the arm modules may be queried as additional data. In particular, both active and passive arm modules may comprise a switch-on unit. It may be provided that the arm modules comprise a plug or connection for the fieldbus on at least one connection face, also known as a flange, which acts as an input and output.

Furthermore, an input and an output for the fieldbus may also be provided on one connection face. Furthermore, other such connection faces may be provided with a further plug or a further connection for the fieldbus or a further input and a further output for the fieldbus. Arm modules may be used that each comprise a connector or connection for a fieldbus on both connection faces. Furthermore, arm modules may also be used on which the robot arm is branched and which therefore have more than two inputs and more than two outputs for the fieldbus. The data telegram passes through each input and each output of each arm module exactly once when passing through the ring line. The fieldbus may include an EtherCAT telegram, for example.

The allocation information of the arm modules is influenced by a respective unique allocation number of the arm modules. The unique allocation number may in particular be a serial number of the arm module. In a simple embodiment, the allocation information may correspond directly to the unique allocation number or the serial number. The method according to the invention may then be used to determine if, for example, one of the arm modules has been replaced, as a different unique allocation number or serial number is now received as allocation information.

The allocation information of the arm modules is influenced by a respective configuration file of the arm modules. On the one hand, data may be stored in the configuration file during the production of the arm module and thus, for example, measurement data linked to the arm module may be passed on. Furthermore, the configuration file may also contain operating data of the respective arm module. This may include, for example, a characteristic curve of a drive motor of the arm module, wherein a change in the characteristic curve may be recognized and written to the configuration file. During the next run of the procedure, a change in the configuration file may then be recognized via the allocation information and, if necessary, movement commands may be adapted, for example if certain speeds and/or accelerations of the drive motor are no longer possible.

The allocation information of the arm modules is calculated as a hash value from the allocation number and the configuration file. When comparing the allocation information of the arm modules with a configuration, the hash values of the arm modules contained in the configuration are compared with the transmitted hash values. For example, the unique allocation number may be available as a string and the configuration file as a string. Both strings are joined together and the hash value of the resulting string is then determined. If the unique allocation number changes even though the modified arm module contains an identical configuration file, the allocation information still changes and the replacement of the arm module may be detected.

The calculation of the hash value is a concrete form of a checksum calculation. If the configuration file changes without the unique allocation number changing, the allocation information also changes. In both cases, the configuration file may be read in order to take any movement restrictions into account. In addition to the described option of calculating the allocation information of the arm modules as a hash value from the allocation number and the configuration file, other alternative calculation methods for checksums are also known and commonly used.

Further data is read out from at least one of the arm modules and/or determined for at least one of the arm modules in order to create the configuration in the configurating step.

It may be provided that further data is read from and/or determined for a plurality of the arm modules or from all of the arm modules in order to create the configuration. It may also be provided that the controller sends a command to one or to a plurality of arm modules that instructs the arm module or arm modules to output the further data to the controller.

The further data of the arm modules include dynamic data. The dynamic data include a mass inertia of the arm modules. The dynamic data may include a mass, a gear friction or a friction in general, center of gravity coordinates and an inertia in the form of an inertia tensor. The dynamic data may include, for example, transmission data such as a transmission ratio, a friction characteristic of the transmission and/or a load limit of the transmission. Furthermore, the dynamic data may include a motor characteristic curve of a drive motor.

This may be used, for example, to avoid overloading the modular robot, particularly the gears of the arm modules, due to excessively fast movements or excessive acceleration. The dynamic data may be used for gravitational compensation during manual guidance. The dynamic data may be used to detect collisions. The dynamic data may be used to control the modular robot. The forces acting on the modular robot, for example due to gravity or acceleration, may be evaluated.

These forces may then be compensated for accordingly. This may be done, for example, as part of a control optimization, such as feedforward control. The amount of torque that needs to be provided by a drive motor in order to perform certain movements may be relevant here. This may improve control and avoid control errors. Furthermore, the control may be faster and more precise and vibration damping may be taken into account. This may also be relevant in connection with the performance limits of the modular robot. First of all, a motion plan for the modular robot may be created in such a way that no overloads occur in relation to set values. The control system may then pre-plan the movements in such a way that the movement may be carried out without any problems.

The further data comprises at least one piece of wear information for an arm module. The controller receives the wear information of the arm module and/or calculates the wear information of the arm module. In addition, the controller uses the wear information to determine a replacement recommendation and outputs the replacement recommendation. The wear information may also be stored in the configuration file of the arm modules, so that a change in the wear information may also be detected using the method according to the invention.

This is particularly useful if the arm modules are set up to determine the wear information. Furthermore, in a modular robot, the wear information is advantageously stored in the arm modules themselves, as this is then also available after a modular robot has been reassembled. For this reason, it may be provided that in the event that the controller determines the wear information, this is passed on to the corresponding arm module and stored in the configuration file. The replacement recommendation may refer to the fact that two identical arm modules in the robot arm should be replaced with one another, for example due to different wear of the two arm modules. In one of these arm modules, for example, a gearbox could have been subjected to greater stress and in the other arm module a drive motor. In this case, it makes sense to swap the two arm modules after a certain time in order to achieve the most homogeneous wear possible. Furthermore, the replacement information could also refer to replacing an arm module with a new one.

Movement information of the arm modules is taken into account in the configurating step. The movement information includes possible movements of the relevant arm module. This may take place both when the configuration is created for the first time and when an updated configuration is created.

The movement information of the arm modules is queried or determined by the controller from the arm modules.

A working space and/or a load-bearing capacity of the robot arm is determined when the configuration is created. This may be done both when the configuration is created for the first time and when an updated configuration is created.

The controller determines whether a configuration of the modular robot is present in a memory. In the event that there is no configuration of the modular robot in the memory, the configuration created in the configurating step is stored in the memory as the initial configuration. The memory may also be assigned to the controller. Alternatively, it may also be an external memory connected to the controller, for example in a network and/or a cloud.

In the event that an initial configuration of the modular robot is present in the memory, the initial configuration present in the memory is compared with the configuration created in the configurating step, wherein in the event that the initial configuration present in the memory matches the created configuration, the initial configuration is used to control the robot arm and in the event that the initial configuration present in the memory does not match the created configuration, the configuration created in the configurating step is stored in the memory and used to control the robot arm. This may save computing time, as the further steps required to create the configuration may be omitted when the procedure is run again, if necessary, as the configuration is already known. In particular, no further data needs to be read from the arm modules.

It may be provided that a total checksum formed from checksums of the allocation information of the arm modules is also stored in the memory and is also determined when the configuration is created. Furthermore, the configuration may also correspond to the total checksum of the configuration formed from checksums of the allocation information of the arm modules. This provides a simple way of comparing the initial configuration in the memory with the created configuration. Alternatively, the initial configuration in the memory may be compared directly with the created configuration.

The configuration comprises possible movements of the robot arm. For this purpose, the controller receives a movement command and checks whether a movement of the robot arm to be executed on the basis of the movement command is possible with the configuration of the modular robot. The movement command may be entered by an operator of the modular robot and thus received. As an alternative or in addition, it may be provided that the movement command is issued to the controller of the modular robot by a central controller of an automation system. This may be the case in particular if the modular robot is used in this automation system. The possible movements of the robot arm may be further data that is transmitted from the arm modules to the controller and read in by the controller. This may take place, for example, when the configuration is created or when an updated configuration is created.

When checking whether a movement of the robot arm determined on the basis of the movement command is possible with the aid of the configuration, it may be provided in particular to check the movement command with regard to the movement of the robot arm in terms of the speed and acceleration with which individual arm modules are to be moved and to compare this with the configuration of the modular robot. It is also possible that more than one movement command is received, in which case the movement commands may include possible movements to be performed.

In the arm module, it is set up to determine the allocation information using a unique allocation number and a configuration file and to store it in the arm module memory.

In the arm module, it is set up to calculate the allocation information of the arm module as a hash value from the allocation number and the configuration file. This may be configured as described above.

In the arm module, movement information, i.e. information regarding possible movements, is stored in the arm module memory. The arm module is set up to output the movement information to the controller of the modular robot.

It is set up to determine wear information on the basis of movements of the arm module and/or on the basis of a measurement of characteristic data, to store it in the arm module memory and to output it to the controller.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a view of a modular robot.

FIG. 2 depicts a method flow chart.

FIG. 3 depicts a method flow chart with further optional steps.

FIG. 4 shows a schematic depiction of a modular robot.

### DETAILED DESCRIPTION

In the following description of the figures, identical elements are marked by identical reference numerals. It is possible that reference numerals are shown in individual figures which are not described in connection with this figure. In this case, the descriptions of these reference numerals, which are described in connection with other figures, may be used to describe the elements marked with these reference numerals. Furthermore, features and properties may be designated as optional in the figure descriptions. These features and properties designated as optional are then not mandatory and may also be omitted, as the case may be.

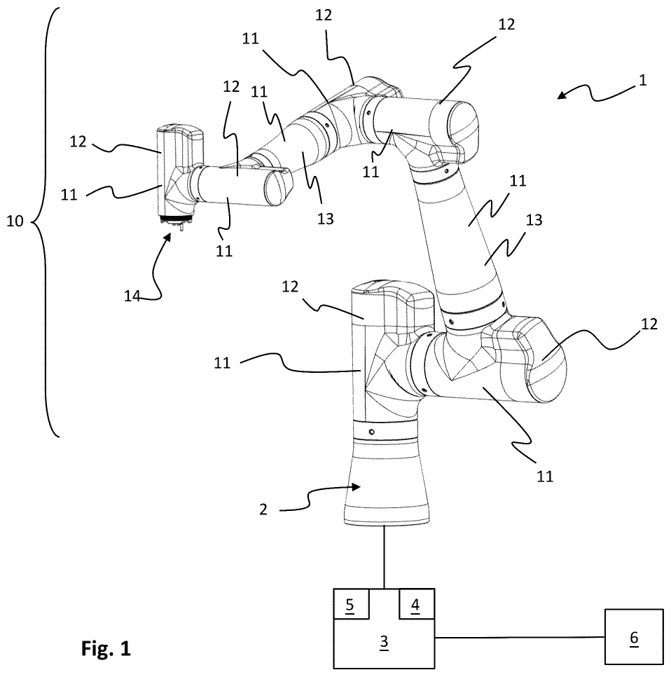

FIG. 1 shows a modular robot 1 having a robot base 2, a robot arm 10 and a controller 3. The robot arm 10 comprises a plurality of arm modules 11 that may be arranged in a modular fashion. The robot base 2 may provide a connection between the robot arm 10 and the controller 3. Furthermore, the robot base 2 may establish a mechanical connection between the robot arm 10 and a base or an attachment area.

The arm modules 11 are optionally either active arm modules 12 or passive arm modules 13. Passive arm modules 13 do not include a motor and serve as an extension of active arm modules 12. Active arm modules 12 include at least a motor. It may be provided that the active arm modules 12 have a rotatable part that may be driven with the aid of the motor. In addition, the robot arm 10 may optionally comprise an end flange 14, wherein the end flange is arranged at one end of the robot arm 10. For example, a tool may be attached to the end flange 14.

Depending on the specification or required movement options for the robot arm 10, the arm modules 11 may be arranged differently, regrouped or replaced by alternative arm modules 11. However, if such a change is made, the modular robot 1 must be reconfigured. The controller 3 is set up to carry out a procedure for operating the modular robot 1, with the aid of which a configuration may be carried out automatically. The controller 3 optionally comprises a computing unit 4 and a memory 5. The controller 3 may be a controller that controls the movements of the modular robot 1. Furthermore, the controller 3 may also be a controller with the aid of which the modular robot 1 is controlled using values measured in the arm modules 11 and thus a control system is present. Furthermore, the controller 3 is optionally connected to an external memory 6.

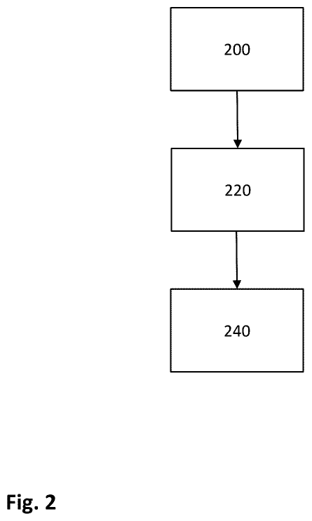

FIG. 2 shows a flow chart of a method for creating a configuration of the modular robot 1. The controller 3 carries out the steps described below. For this purpose, it may be provided that the controller 3 comprises the computing unit 4, on which a program runs that causes the controller 3 to carry out the method steps. First, allocation information is received from each of the arm modules in an allocation determining step 200. Then, arm module base data is determined based on the allocation information for each arm module in an arm module base data determining step 220. Subsequently, in a configurating step 240, a configuration of the modular robot is created from the allocation information and the arm module base data of the individual arm modules, wherein the configuration may be used to control the robot arm.

Optionally, allocation information of the robot base 2 may be received in the allocation determining step 200. As an alternative or in addition, arm module base data of the robot base 2 may be determined in the arm module base data determining step 220. In these cases, the allocation information of the robot base 2 and/or the arm module base data of the robot base 2 may be taken into account when creating the configuration of the modular robot 1 in the configurating step 240.

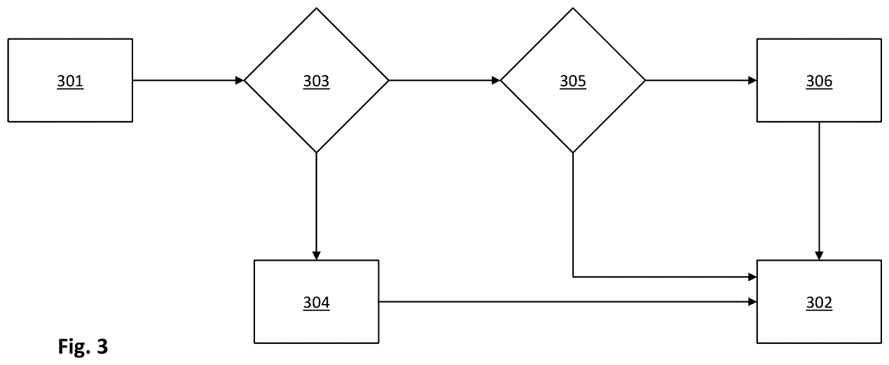

FIG. 3 shows a flow chart of a method for operating the modular robot 1. The controller 3 carries out the steps described below. For this purpose, it may be provided that the controller 3 comprises the computing unit 4, on which a program runs that causes the controller 3 to perform the method steps. In a first method step 301, a configuration of the modular robot 1 is created.

This may be carried out according to the method described in connection with FIG. 2. In a second method step 302, the configuration is used to control the robot arm 10. Furthermore, FIG. 3 shows additional, optional method steps which relate to embodiments and which are explained below.

In an optional third method step 303, it is determined whether a configuration of the modular robot 1 is present in a memory 5, 6. The third method step 303 is carried out after the first method step 301 and prior to the second method step 302. In the event that no configuration of the modular robot 1 is provided, the configuration is stored in the fourth method step 304 as an initial configuration in the memory 5, 6. If the third method step 303 shows that an initial configuration of the modular robot 1 is provided in a memory 5, 6, the optional fifth method step 305 may be carried out.

In the fifth method step 305, the initial configuration provided in the memory 5, 6 is compared with the created configuration. In the event that the initial configuration provided in the memory 5, 6 matches the created configuration, the second method step 302 may be executed directly and the initial configuration may be used to control the robot arm 10. In the event that the initial configuration provided in the memory 5, 6 does not match the created configuration, the created configuration is stored in the memory 5, 6 in a sixth method step 306.

Depending on the conditions provided in the third method step 303 or fifth method step 305, the method thus comprises either the execution of the first method step 301, the third method step 303, the fourth method step 304 and the second method step 302 or the execution of the first method step 301, the third method step 303, the fifth method step 305 and the second method step 302 or the execution of the first method step 301, the third method step 303, the fifth method step 305, the sixth method step 306 and the second method step 302.

The controller 3 may therefore be used to determine a configuration of the modular robot 1 and, as the case may be, to determine changes to the configuration. The modular robot 1 may then be controlled using the configuration. The memory used in the method may be allocated to the controller 3, as shown in FIG. 1. Alternatively, however, it may also be an external memory 6 connected or connectable to the controller 3, for example in a network and/or a cloud. If it is determined in the fifth method step 305 that the initial configuration present in the memory 5, 6 matches the created configuration, the initial configuration may be used for the execution of the second method step 302 and, if necessary, computing time may be saved, since no further data from the arm modules 11 need be queried, since these may already be included in the initial configuration.

In an embodiment of the method, the configuration comprises possible movements of the robot arm 10. The controller 3 also receives a movement command, for example in the sixth method step 306 or prior to the sixth method step 306. Furthermore, after receiving the movement command, the controller checks whether a movement of the robot arm 10 determined on the basis of the movement command is possible with the configuration. If this is not the case, an error message may be output, as the case may be. The possible movements of the robot arm 10 may be further data that is transmitted from the arm modules 11 to the controller 3 and read in by the controller 3. This may take place, for example, when the configuration is created or when the updated configuration is created.

The movement command may be entered by an operator of the modular robot 1 and thus received. As an alternative or in addition, it may be provided that the movement command is issued to the controller 3 of the modular robot 1 by a central controller of an automation system. This may be the case in particular if the modular robot 1 is used in this automation system.

When checking whether a movement of the robot arm 10 determined on the basis of the movement command is possible with the configuration, it may in particular be intended to check the movement command with regard to the movement of the robot arm 10 in terms of the speed and acceleration by which individual arm modules 11 are to be moved and to compare this with the configuration of the modular robot 1. Furthermore, it may be provided that more than one movement command is received, in which case the movement commands may comprise different possible movements to be performed.

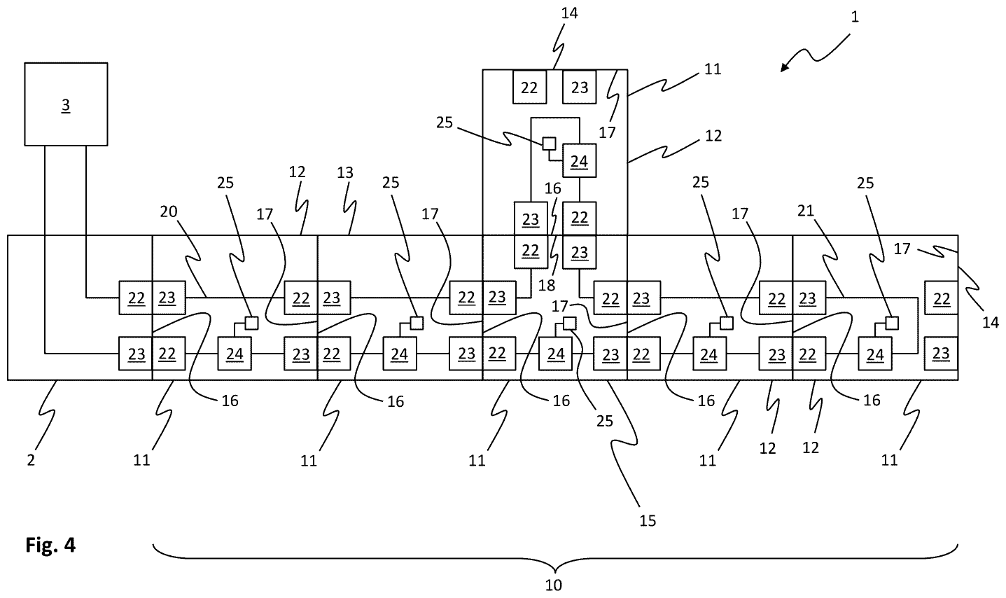

FIG. 4 shows a schematic depiction of a further modular robot 1. The arm modules 11 of the robot arm are shown in less detail than in FIG. 1, but the inner workings of the arm modules 11 are shown schematically. Otherwise, the arm modules 11 may be constructed in the same way as in FIG. 1. Furthermore, there are again active arm modules 12 and passive arm modules 13 analogous to FIG. 1.

In contrast to FIG. 1, the robot arm 10 in this embodiment example also comprises a branching arm module 15. The branching arm module 15 allows the robot arm 10 to branch. This is achieved by the fact that three arm modules 10 may be attached to the branching arm module 15, while only two arm modules 10 may be attached to each of the other arm modules 11. The branching arm module 15 may be an active arm module or a passive arm module. The arm modules 11, including the robot base 2, are connected to one another via a field bus 20. Data may be exchanged between the arm modules 11 and the controller 3 via the field bus 20. In the allocation determining step 200, the controller 3 uses a sequence of the allocation information of the arm modules 11 in a telegram of the field bus 20 to determine a mechanical structure of the robot arm 10.

In particular, it may be provided that a data telegram is sent out by the controller 3 and that the field bus 20 sends the data telegram via a ring line 21 through all arm modules 11 and then the data telegram returns to the controller 3. Each arm module 11 is a bus subscriber and comprises at least two inputs 22 and two outputs 23 for the field bus 20. Furthermore, each arm module 11 comprises a switch-on unit 24 for the field bus 20 and optionally an arm module memory 25. Each switch-on unit 24 may then write the allocation information into the data telegram, for example at the request of the controller 3. The sequence of the allocation information of the arm modules 11 stored in the data telegram may then be used to infer the sequence of the arm modules 11 in the robot arm 10.

In particular, as shown in FIG. 4, both active arm modules 12 and passive arm modules 13 may comprise a switch-on unit 24. The branching arm module 15 comprises more than two inputs 22 and more than two outputs 23 for the field bus 20. When passing through the ring line 21, the data telegram passes through each input 22 and each output 23 of each arm module 11 exactly once, except for the inputs 22 and outputs 23 arranged at the end flanges 14. It may be provided that the arm modules are internally connected in such a way that the switch-on unit 24 is connected to the input 22 via which the data telegram reaches the relevant arm module 11 for the first time. This may also be achieved with an electronic circuit within the arm modules 11, so that the arm modules 11 may also be installed in a rotated position.

Furthermore, it may be provided that the end flanges 14 are detected by recognizing that no further arm modules are arranged at the end flanges 14 and therefore the ring line 21 is closed by connecting the input 22 and the output 23 on one side of the arm module 11 to one another, as shown in the arm modules 11 with the end flanges 14 in FIG. 4. Furthermore, the data telegram may pass through the switch-on unit 24 a second time when it passes through an arm module 11 for the second or third time, wherein writing only takes place the first time it passes through the switch-on unit 24. The field bus 20 may be EtherCAT, for example.

Furthermore, FIG. 4 shows that the arm modules 11 each comprise a first flange 16 and a second flange 17, with the branching arm module 15 also having a third flange 18. The inputs 22 and outputs 23 are each arranged in such a way that an input 22 and an output 23 are arranged on the first flange 16, an input 22 and an output 23 are arranged on the second flange 17 and, for the branching arm module 15, an input 22 and an output 23 are also arranged on the third flange 18. For the arm modules 11 with the end flanges 14, the second flanges 16 are in each case the end flanges 14. Contrary to the illustration in FIG. 4, it may be provided that the input 22 and the output 23 are arranged in a combined connection on each of the flanges 16, 17, 18.

In an embodiment of the method, the allocation information of the arm modules 11 is influenced by a respective unique allocation number of the arm modules 11. The unique allocation number may in particular be a serial number of the arm module 11. In a simple embodiment, the allocation information may correspond directly to the unique allocation number or the serial number. The method according to the invention may then be used to determine if, for example, one of the arm modules 11 has been replaced, as a different unique allocation number or serial number is now received as allocation information by the controller 3. The unique allocation number, in particular the serial number, may be stored in the arm module memory 25, for example.

In an embodiment of the method, the allocation information of the arm modules 11 is influenced by a respective configuration file of the arm modules. On the one hand, data may be stored in the configuration file during production of the arm module and thus, for example, measurement data associated with the arm module 11 may be passed on.

Furthermore, the configuration file may also contain operating data of the respective arm module 11. This may include, for example, a characteristic curve of a drive motor of the arm module 11, wherein a change in the characteristic curve may be recognized and written to the configuration file. During the next run of the procedure, a change in the configuration file may then be recognized via the allocation information and, if necessary, movement commands may be adapted, for example if certain speeds and/or accelerations of the drive motor are no longer possible. The configuration file may, for example, be stored in the arm module memory 25.

In an embodiment of the method, the allocation information of the arm modules 11 is calculated as a hash value from the allocation number and the configuration file. When comparing the allocation information of the arm modules 11 with a configuration, the hash values of the arm modules 11 contained in the configuration are compared with the transmitted hash values. For example, the unique allocation number may be available as a string and the configuration file as a string. Both strings are joined together and the hash value of the resulting string is then determined.

If the unique allocation number changes even though the modified arm module 11 has an identical configuration file, the allocation information still changes and the replacement of the arm module 11 may be detected. If the configuration file changes without the unique allocation number changing, the allocation information also changes. In both cases, the configuration file may be read out in order to take any movement restrictions into account. In addition to the described option of calculating the allocation information of the arm modules 11 as a hash value from the allocation number and the configuration file, other alternative calculation methods are also known and common.

In an embodiment of the method, the controller 3 also receives wear information of the arm modules 11 and/or calculates wear information of the arm modules 11. In addition, the controller 3 uses the wear information to determine a replacement recommendation and outputs the replacement recommendation. The wear information may also be stored in the configuration file of the arm modules 11, so that a change in the wear information may also be recognized by the method according to the invention.

This is particularly useful if the arm modules 11 are set up to determine the wear information themselves. Furthermore, in a modular robot 1, the wear information is advantageously stored in the arm modules 11 themselves, for example in the arm module memory 25, as this is then also available after reassembly of a further modular robot 1 with arm modules 11 already in use. For this reason, it may also be provided that in the event that the controller 3 determines the wear information, this is passed on to the corresponding arm module 11 and stored in the configuration file.

The replacement recommendation may refer to the fact that two identical arm modules 11 in the robot arm 10 should be replaced with one another, for example due to different wear of the two arm modules 1. In one of these arm modules 11, for example, a gearbox could have been subjected to greater stress than the gearbox of another arm module 11. It then makes sense to replace the two arm modules 11 after a certain period of time in order to achieve the most homogeneous wear possible. Furthermore, the replacement information could also refer to replacing one arm module 11 with a new one.

In an embodiment of the method, movement information of the arm modules 11 is taken into account when creating the configuration. The movement information includes possible movements of the relevant arm module 11. In particular, the movement information may include the positions in which the first flange 16, the second flange 17 and possibly the third flange 18 may be moved relative to one another. This may be done both when the configuration is first created and when the updated configuration is set.

In an embodiment of the method, a working space and/or a load-bearing capacity of the robot arm 10 is determined when the configuration is created. This may be done both when the configuration is created for the first time and when the updated configuration is created.

In an embodiment of the method, the movement information of the arm modules 11 is queried by the arm modules 11.

In an embodiment of the method, the arm module base data of the arm modules 11 include kinematic data. The kinematic data include a relative position of the first flange 16 and the second flange 17 of the respective arm modules 11. The arm modules 11 could thereby be connected to one another and/or to a tool via the first flanges 16 and the second flanges 17, respectively, wherein the tool may in particular be connected to an end flange 14. Furthermore, the kinematic data may be determined during the production of the arm module 11 theoretically with the aid of simulation or practically with the aid of measurement. The kinematic data may be stored in the form of a 4×4 transformation matrix or as Denavit-Hartenberg parameters.

The kinematic data then allows a kinematic description of the entire modular robot 1 to be generated. This kinematic description may be used to plan the movements of the robot arm 10. This may be embodied in particular as Cartesian monitoring, in which a speed of a point, for example a tool center point, an L-bend of a robot arm 10 or one of the flanges 14, 16, 17, 18 is monitored. A volume of a tool may be taken into account and a plurality of points of the tool, for example a gripper, may also be monitored.

Furthermore, space monitoring, monitoring the geometry of the modular robot 1 in relation to a space and/or a geometric object, monitoring whether the modular robot 1 occupies a certain space and/or checking whether the modular robot 1 is within a permitted range of movement are possible. This may be used, for example, in a material loading station of an automation system. If a human operator and/or a part of the human operator's body is in the area of the material loading station, for example behind an open roller shutter, the material loading station may be blocked for the modular robot 1.

As soon as the human operator is no longer in the area of the material loading station, the space is unblocked again and the modular robot 1 may then move there again. Spaces may also be used as switches. Although the modular robot 1 may occupy this space, the modular robot 1 must move more slowly here. Different logic functions and this information may be used accordingly to generate a monitoring function. It may be necessary to monitor states of the modular robot 1, such as a speed, a location and/or an orientation of the tool, or to logically interconnect states. A calculation of a forward transformation may be important for this.

The kinematic data may include a three-dimensional model of the modular robot 1, with which, for example, a shell or external dimensions of the modular robot 1 may be taken into account. In particular, the external dimensions of the modular robot 1 may be influenced by the external dimensions of the individual arm modules 11. The kinematic data may also include kinematic correction data. The kinematic correction data may describe deviations from design data that arise, for example, due to inaccuracies during assembly.

In an embodiment of the method, the further data of the arm modules 11 include dynamic data. The dynamic data include a mass inertia of the arm modules 11. The dynamic data may include a mass, a gear friction or a friction in general, center of gravity coordinates and an intrinsic inertia in the form of an inertia tensor. The dynamic data may include, for example, transmission data such as a transmission ratio, a friction characteristic of the transmission and/or a load limit of the transmission. Furthermore, the dynamic data may include a motor characteristic curve of a drive motor.

This may be used, for example, to avoid overloading the modular robot 1, in particular the gears of the arm modules 11, due to excessively fast movements or excessive acceleration. The dynamic data may be used for gravitational compensation during manual guidance. The dynamic data may be used to detect collisions with the robot's own arm or foreign objects. The dynamic data may be used to control the modular robot 1.

The forces acting on the modular robot 1, for example due to gravity or acceleration, may be evaluated. These forces may then be balanced accordingly. This may be done, for example, as part of a control optimization, such as feedforward control. It may be relevant how much torque must be provided by a drive motor in order to perform certain movements. This may improve control and avoid control errors. Furthermore, the control may be faster and more precise and vibration damping may be taken into account. This may also be relevant in connection with the performance limits of the modular robot 1. First of all, a motion plan for the modular robot may be created in such a way that no overloads occur in relation to target values. The control system may then pre-plan the movements so that the movement may be carried out without any problems.

A further part of the invention is the controller 3 for a modular robot 1, which is set up to carry out the method explained in connection with FIG. 2 or one of its embodiments. The controller 3 may have a connection for the field bus 20 for this purpose. A further part of the invention is the modular robot 1 with the robot arm 10 and the controller 3.

An arm module 11 for a modular robot 1 comprises an arm module memory 25. Allocation information is stored in the arm module memory 25. The arm module 11 is configured to output the allocation information to a controller 3 of the modular robot 1.

In an embodiment of the arm module 11, it is set up to determine the allocation information using a unique allocation number and a configuration file and to store it in the arm module memory 25.

In an embodiment of the arm module 11, it is set up to calculate the allocation information of the arm module 11 as a hash value from the allocation number and the configuration file. This may be configured as described above.

In an embodiment of the arm module 11, movement information, i.e. information regarding possible movements, is stored in the arm module memory 25. The arm module 11 is set up to output the movement information to the controller 3 of the modular robot 1.

In an embodiment example of the arm module 11, it is set up to determine wear information on the basis of movements of the arm module 11 and/or on the basis of a measurement of characteristic data, to store it in the arm module memory 25 and to output it to the controller 3. This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
Table 1. List of reference numerals

| | |
|---|---|
| 1 | modular robot |
| 2 | robot base |
| 3 | controller |
| 4 | computing unit |
| 5 | memory |
| 6 | external memory |
| 10 | robot arm |
| 11 | arm module |
| 12 | active arm module |
| 13 | passive arm module |
| 14 | end flange |
| 15 | branching arm module |
| 16 | first flange |
| 17 | second flange |
| 20 | field bus |
| 21 | ring circuit |
| 22 | input |
| 23 | output |
| 24 | switch-on unit |
| 25 | arm module memory |
| 200 | allocation determining step |
| 220 | arm module base data determining step |
| 240 | configurating step |
| 301 | first method step |
| 302 | second method step |
| 303 | third method step |
| 304 | fourth method step |
| 305 | fifth method step |
| 306 | sixth method step |

What is claimed is:

1. A method for operating a modular robot, the modular robot comprising:
a robot base,
at least a robot arm arranged on the robot base, and
a controller,
the robot arm comprising a plurality of arm modules configured to be arranged in a modular manner;
the method comprising the controller carrying out the following steps:
receiving allocation information from each of the arm modules in an allocation determining step;
determining arm module base data based on the allocation information for each arm module in an arm module base data determining step;
creating a configuration of the modular robot from the allocation information and the arm module base data of the individual arm modules in a configurating step, wherein the configuration is used to control the robot arm.

2. The method according to claim 1, wherein additionally in the allocation determining step, allocation information of the robot base is received and/or in the arm module base data determining step, arm module base data of the robot base is determined, wherein the allocation information of the robot base and/or the arm module base data of the robot base is taken into account when creating the configuration of the modular robot in the configurating step.

3. The method according to claim 1, wherein the arm module base data includes at least kinematic data, wherein the kinematic data includes a relative position of a first flange and a second flange of the respective arm modules and/or the robot base.

4. The method according to according to claim 1, wherein the controller, the robot base and the arm modules forming the robot arm are connected to one another via a field bus and data are exchanged between the arm modules, the robot base and the controller via the field bus, wherein a mechanical structure of the robot arm is determined by the controller in the allocation determining step on the basis of a sequence of the allocation information of the arm modules in a telegram of the field bus.

5. The method according to according to claim 1, wherein the allocation information of the arm modules is influenced by a respective unique allocation number of the arm modules.

6. The method according to claim 1, wherein the allocation information of the arm modules is influenced by a respective configuration file of the arm modules, wherein the allocation information of the arm modules is calculated as a hash value from the allocation number and the configuration file.

7. The method according to claim 1, wherein further data is read out from at least one of the arm modules and/or determined for at least one of the arm modules to create the configuration in the configurating step, wherein the further data of the arm modules include dynamic data, wherein the dynamic data include a mass inertia of the arm modules.

8. The method according to claim 1, wherein further data is read out from at least one of the arm modules and/or determined for at least one of the arm modules to create the configuration in the configurating step, wherein the further data comprise at least one wear information for an arm module, wherein the controller receives the wear information of the arm module and/or calculates a wear information of the arm module and determines and outputs a replacement recommendation for the arm module based on the wear information.

9. The method according to claim 1, wherein:
the controller further determines whether a configuration of the modular robot is present in a memory,
wherein, in the event that no configuration of the modular robot is present in the memory, the configuration created in the configurating step is stored as initial configuration in the memory; and
wherein, in the event that an initial configuration of the modular robot is present in the memory, the initial configuration present in the memory is compared to the configuration created in the configurating step,
wherein, in the event that the initial configuration present in the memory matches the configuration created in the configurating step, the initial configuration is used to control the robot arm and,
in the event that the initial configuration present in the memory does not match the configuration created in the configurating step, the configuration created in the configurating step is used to control the robot arm, the initial configuration is used to control the robot arm, and
in the event that the initial configuration present in the memory does not match the configuration created in the configurating step, the configuration created in the configurating step is stored in the memory and used to control the robot arm.

10. A method for operating a modular robot, the modular robot comprising:
a robot base,
at least a robot arm arranged on the robot base, and
a controller,
wherein the controller, the robot base and the arm modules forming the robot arm are connected to one another via a field bus and data are exchanged between the arm modules, the robot base and the controller via the field bus,
wherein a data telegram is sent out by the controller and the field bus sends the data telegram through all arm modules via a ring line and subsequently the data telegram returns to the controller, and
wherein each arm module is a bus subscriber and comprises a switch-on unit for the field bus;
the method comprising the controller carrying out the following steps:
receiving allocation information from each of the arm modules in an allocation determining step, wherein each switch-on unit writes the allocation information into the data telegram, wherein the allocation information of each arm module includes a unique allocation number;
determining arm module base data based on the allocation information for each arm module in an arm module base data determining step, wherein the arm module base data include at least kinematic data;
creating a configuration of the modular robot from the allocation information and the arm module base data of the individual arm modules in a configurating step, wherein on the basis of the order of the allocation information of the arm modules, a mechanical structure of the robot arm is determined in the data telegram of the field bus; and
controlling the robot arm on the basis of the configuration.

11. The method according to claim 10, wherein additionally in the allocation determining step, allocation information of the robot base is received and/or in the arm module base data determining step, arm module base data of the robot base is determined, wherein the allocation information of the robot base and/or the arm module base data of the robot base is taken into account when creating the configuration of the modular robot in the configurating step.

12. The method according to claim 10, wherein the kinematic data of the arm module base data includes a relative position of a first flange and a second flange of the respective arm modules and/or the robot base.

13. The method according to claim 10, wherein the allocation information of the arm modules is influenced by a respective configuration file of the arm modules, wherein the allocation information of the arm modules is calculated as a hash value from the allocation number and the configuration file.

14. The method according to claim 10, wherein further data is read out from at least one of the arm modules and/or determined for at least one of the arm modules to create the configuration in the configurating step, wherein the further data of the arm modules include dynamic data, wherein the dynamic data include a mass inertia of the arm modules.

15. The method according to claim 10, wherein further data is read out from at least one of the arm modules and/or determined for at least one of the arm modules to create the configuration in the configurating step, wherein the further data comprise at least one wear information for an arm module, wherein the controller receives the wear information of the arm module and/or calculates a wear information of the arm module and determines and outputs a replacement recommendation for the arm module based on the wear information.

16. The method according to claim 10, wherein a movement information of the arm modules is taken into account in the configurating step, wherein the movement information of the respective arm modules comprises possible movements of the respective arm module.

17. The method according to claim 10, wherein a working space and/or a load capacity of the robot arm is determined when creating the configuration in the configurating step.

18. The method according to claim 10, wherein:
the controller further determines whether a configuration of the modular robot is present in a memory,
wherein, in the event that no configuration of the modular robot is present in the memory, the configuration created in the configurating step is stored as initial configuration in the memory, and
wherein, in the event that an initial configuration of the modular robot is present in the memory, the initial configuration present in the memory is compared to the configuration created in the configurating step,
wherein, in the event that the initial configuration present in the memory matches the configuration created in the configurating step, the initial configuration is used to control the robot arm and, in the event that the initial configuration present in the memory does not match the configuration created in the configurating step, the configuration created in the configurating step is used to control the robot arm, the initial configuration is used to control the robot arm, and
in the event that the initial configuration present in the memory does not match the configuration created in the configurating step, the configuration created in the configurating step is stored in the memory and used to control the robot arm.

19. A controller for operating a modular robot, the modular robot comprising:
a robot base, and
at least a robot arm arranged on the robot base,
wherein a controller, the robot base and arm modules forming the robot arm are connected to one another via a field bus and data are exchanged between the arm modules, the robot base and the controller via the field bus,
wherein a data telegram is sent out by the controller and the field bus sends the data telegram through all the arm modules via a ring line and subsequently the data telegram returns to the controller,
wherein each arm module is a bus subscriber and comprises a switch-on unit for the field bus,
wherein the controller receives allocation information from each of the arm modules in an allocation determining step, wherein each switch-on unit writes the allocation information into the data telegram, wherein the allocation information of each arm module includes a unique allocation number,
wherein the controller determines arm module base data based on the allocation information for each arm module in an arm module base data determining step,
wherein the arm module base data include at least kinematic data,
wherein the controller creates a configuration of the modular robot from the allocation information and the arm module base data of the individual arm modules in a configurating step,
wherein on the basis of the order of the allocation information of the arm modules, a mechanical structure of the robot arm is determined in the data telegram of the field bus, and
wherein the controller controls the robot arm on the basis of the configuration.

20. A modular robot having a robot arm and a controller configured to carry out the method of claim 19.
